(19) United States
(12) Patent Application Publication
(10) Pub. No.: US 2004/0049798 A1
(43) Pub. Date: Mar. 11, 2004

(54) Computer system and data transmitting method thereof

(75) Inventor: Ho-Jin Ha, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/656,110

(22) Filed: Sep. 8, 2003

(30) Foreign Application Priority Data
Sep. 9, 2002 (KR) 2002-54252

(51) Int. Cl. H04N 7/18; H04N 7/173; H04N 7/16; H04N 7/00; H04N 11/00; G06F 1/04; G06F 1/12; G06F 5/06

(52) U.S. Cl. 725/133; 713/600; 725/141; 725/80; 348/552

(57) ABSTRACT

The present invention relates to a computer system enabling data stored in a hard disk to be outputted to an external apparatus through a display apparatus and a data transmitting method thereof.

### CROSS-REFERENCE TO RELATED APPLICATIONS

This application claims the benefit of Korean Application No. 2002-54252, filed Sep. 9, 2002, in the Korean Intellectual Property Office, the disclosure of which is incorporated herein by reference.

### BACKGROUND OF THE INVENTION

1. Field of the Invention

The present invention relates to a computer system, and more particularly, to a computer system having a display apparatus enabling data transmitted through a computer body to be outputted to an external apparatus and a data transmitting method thereof.

2. Description of the Related Art

Generally, a portable computer comprises a computer body that includes a system having a micom (Microcomputer) and hardware such as a hard disk, a memory, and a video chip; and an LCD apparatus that is connected to the computer body by a hinge and that displays a picture according to a picture signal provided from the video chip.

According to a conventional computer system, a digital picture signal was converted to an analog picture signal and provided to the LCD apparatus by an analog transmission, and the LCD apparatus converted the analog picture signal to the digital picture signal and then processed the signal. Thus, the LCD apparatus had to include an ADC (Analog to Digital Converter) additionally. However, the analog transmission has a problem that a signal loss is generated. Also, the LCD apparatus had to include the ADC, thereby increasing its cost.

Thus, a method in which a picture signal is transmitted as a digital signal (not an analog signal) is standardized with the goal of preventing quality degradation of a picture and reducing cost for a display apparatus such as an LCD apparatus processing the digital signal received from the outside to display the picture. For example, the DVI (DIGITAL VISUAL INTERFACE) is standardized by the DDWG (Digital Display Working Group). According to the DVI standard, a digital picture signal is transmitted by using a TMDS (Transition Minimized Differential Signals) link that SILICON IMAGE INC. has developed, and picture signals of respective RGB channels are transmitted to a base band by setting up data channels of the respective RGB channels and a clock channel of 1 channel. Also, according to the DVI standard, a 12C bus is used as a duplex serial channel having relatively slow transmission speed compared with transmission speed of high speed serial bus. Further, the 12C bus is also used as a channel of the DDC (Display Data Channel) standard for the P&P (Plug and Play) standardized by the VESA (Video Electronics Standards Association).

In the meanwhile, in order to communicate data among two or more computer systems, a network card, that is a LAN (local area network) card, must be installed and computer bodies have to be connected by using a LAN line. Also, disclosed is a method in which parallel ports of two computer systems are connected by using a connector, and in which a separate data transmitting program is installed in the computer body, to thereby enable the data to be communicated.

The conventional display apparatus is simply provided with a video signal from the computer body and only displays a picture according to the video signal. Thus, if a data transmitting function is implemented through a display apparatus by using a high speed digital transmission method of the TDMS, utility of the display apparatus is increased. Also, as data is transmitted by using high speed digital transmission method of the TDMS, data transmitting speed will be relatively increased, compared with the conventional data transmitting speed between computers.

### SUMMARY OF THE INVENTION

Accordingly, it is an aspect of the present invention to provide a computer system enabling data stored in a hard disk to be outputted to an external apparatus through a display apparatus and a data transmitting method thereof.

Additional aspects and/or advantages of the present invention will be set forth in part in the description that follows and, in part, will be obvious from the description, or may be learned by practicing the present invention.

The foregoing and/or other aspects of the present invention are achieved by providing a computer system comprising a computer body, comprising a hard disk to store user data, a video connector to transmit data, a video processing part to generate video data, a video memory to temporarily store the video data generated through the video processing part and the user data stored in the hard disk, a data transmitting part to output the video data and the user data temporarily stored in the video memory through the video connector; and a display apparatus comprising a display part, a body connection part to connect to the video connector of the computer body, an external apparatus connecting part to connect to an external apparatus, a data receiving part to receive the video data and the user data provided from the computer body through the body connection part, a control part to display the video data received through the data receiving part to the display part and to output the user data to the external apparatus connected to the external apparatus connecting part.

According to embodiments of the present invention, the data transmitting part and the data receiving part respectively may comprise a TMDS (Transition Minimized Differential Signals) transmitter and a TMDS receiver to compress/extract data according to a TMDS-based digital data transmission standard.

According to embodiments of the present invention, the TMDS transmitter may have RGB data output pins, and may compress the user data and the video data provided from the video memory in a predetermined ratio to output a compressed user and video data through the respective RGB data output pins.

According to embodiments of the present invention, the control part may comprise a signal separating part to separate digital data extracted in the data receiver into the video data and the user data.

According to embodiments of the present invention, the display apparatus may have a buffer temporarily storing the user data received through the data receiving part.

According to embodiments of the present invention, the computer body may further comprise a parallel-serial converting part to convert the user data stored in the hard disk to serial data, wherein the parallel-serial converting part outputs a converted serial data to the display apparatus through a predetermined pin of the video connector.

The foregoing and/or other aspects of the present invention are also achieved by providing a data transmitting method of a computer system including a computer body having a hard disk to store user data, a video processing part to generate video data, and a video connector through which the generated video data is outputted; and a display apparatus having a body connection part to be connected to the video connector, comprising providing an external apparatus connecting part in the display apparatus; storing the video data and the user data of the hard disk in a memory; transmitting the data stored in the memory to the display apparatus through the video connector; and displaying the video data of a transmitted data as a picture and outputting the user data of the transmitted data to an external apparatus connected to the external apparatus connecting part.

According to embodiments of the present invention, the data transmitting method of the computer system may further comprise compressing the user data and the video data according to a TMDS-based digital data transmission standard, before transmitting the data from the computer body to the display apparatus.

According to embodiments of the present invention, the data transmitting method of the computer system may further comprise extracting the data; and separating an extracted data into the video data and the user data.

According to embodiments of the present invention, the data transmitting method of the computer system may further comprise setting up a predetermined pin of the video connector as a data transmission pin; and converting the user data to serial data, wherein transmitting the data comprises outputting a converted serial data to the display apparatus through the data transmission pin.

### BRIEF DESCRIPTION OF THE DRAWINGS

These and/or other aspects and advantages of the present invention will become apparent and more readily appreciated from the following description of preferred embodiments, taken in conjunction with the accompanying drawings of which:

FIG. 1 is a front view of a computer system according to an embodiment of the present invention;

FIG. 2 is a control block diagram of the computer system FIG. 1;

FIG. 3 is a flow diagram illustrating a data transmitting method of a computer system having the control block of FIG. 2;

FIG. 4 is a control block diagram of the computer system according to another embodiment of the present invention;

FIG. 5 is a flow diagram illustrating a data transmitting method of a computer system having the control block of FIG. 4;

FIG. 6 is a view illustrating a user interface picture for transmitting a user data stored in a hard disk of the computer system to a display apparatus; and

FIG. 7 is a view illustrating a chart describing pins of a digital video connector.

### DETAILED DESCRIPTION OF THE PREFERRED EMBODIMENTS

Reference will now be made in detail to the embodiments of the present invention, examples of which are illustrated in the accompanying drawings, wherein like elements will be given like reference numbers throughout, and repetitive description will be avoided as necessary.

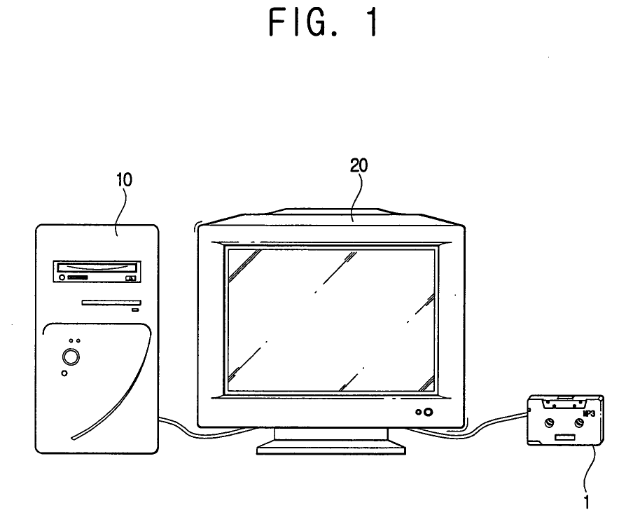

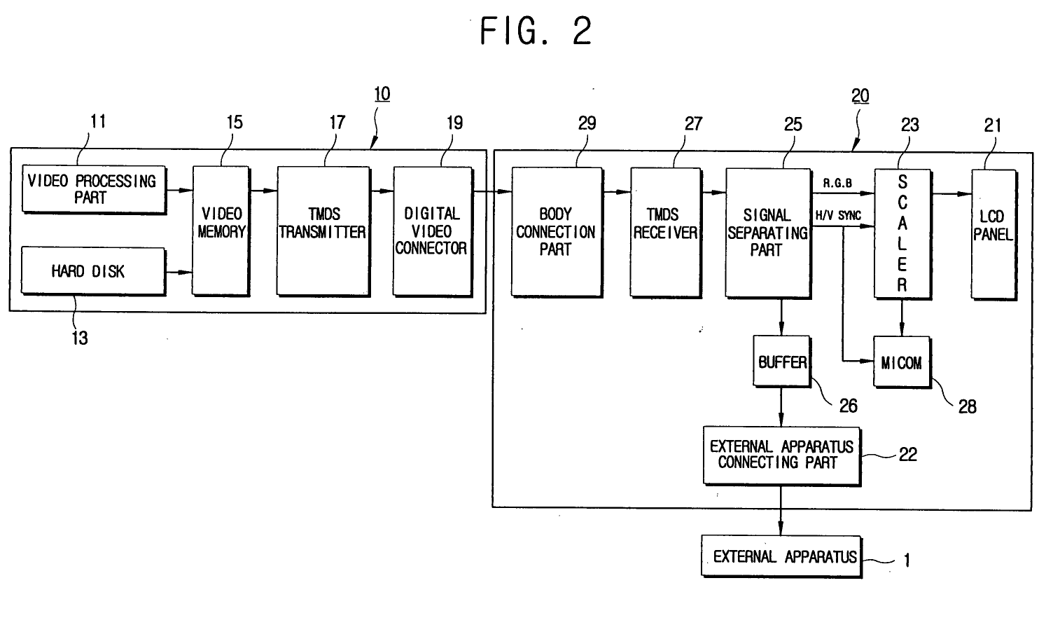

FIG. 1 is a front view of a computer system to which a separate external apparatus is connected, according to an embodiment of the present invention. As shown in FIG. 1, the computer system according to the present invention comprises a computer body 10 that comprises a video connector; an LCD apparatus 20 that comprises a body connecting part connected to the video connector, processing video data received from a video card of the computer body 10 and displaying an image, for example, a picture, according to a processed video data. According to the present invention, the LCD apparatus 20 further comprises an external apparatus connecting part 22 (refer to FIG. 2) and an external apparatus 1 (in a below embodiment, an MP3 player) capable of storing data is connected thereto.

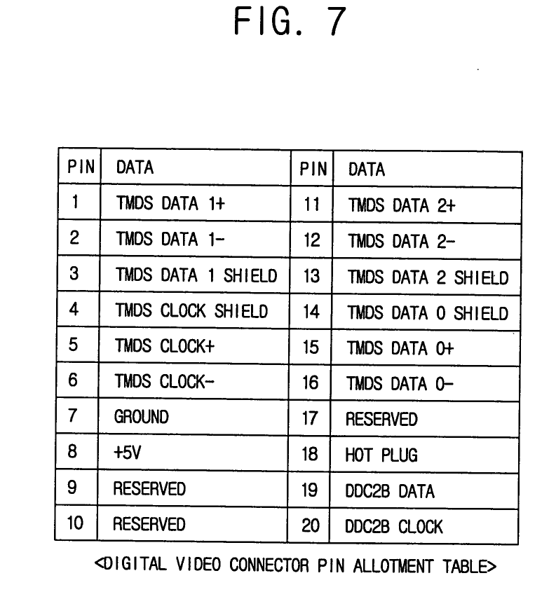

The computer body 10 comprises the video card, which comprises a video processing part 11 (refer to FIG. 2) to generate the video data, a video memory 15 (refer to FIG. 2) to temporarily store the video data and to output the video data through the video connector, and a TMDS (Transition Minimized Differential Signals) transmitter 17 (refer to FIG. 2) compressing the video data according to a TMDS-based digital data transmission standard. At this time, the video connector is a digital video connector having pins allotted as shown in FIG. 7.

FIG. 2 is a control block diagram of the portable computer according to the present invention. The computer system comprises the computer body 10 having a hard disk 13 to store user data, and the LCD apparatus 20 to buffer the user data received from the computer body 10 and to output to the external apparatus 1.

The computer body 10 comprises a CPU (not shown) to perform operation and control; the hard disk 13 to store an OS (operating system) and other application programs, and the user data; the video processing part 11 to process a digital picture signal, and to output an RGB signal and vertical and horizontal synchronizing signals; the video memory 15 to temporarily store the user data stored with the hard disk 13 and the data generated from the video processing part 11; and the TMDS transmitter 17 to compress a video signal outputted from the video memory 15 as digital data so as to transmit the video signal at high speed. A data transmitting control program is stored in the hard disk 13. The data transmitting control program is executed according to a selection of a predetermined data transmitting selecting part, and thus the video memory 15 and the TMDS transmitter 17 are set up in a data transmitting mode.

The TMDS transmitter 17 has a plurality of data output pins to output compressed H/V synchronizing signals and RGB video data (refer to FIG. 7). The TMDS transmitter 17 compresses the video data provided and the user data from the video memory 15 with the RGB video data and outputs compressed data to the LCD apparatus 20 through RGB output pins. Preferably, the TMDS transmitter 17 is set up so that the RGB data is transmitted, compressed in a 40:1 ratio per one clock. The set-up can be performed by a driver (an application program for hardware set-up control) to change set-up of the video memory 15 and the TMDS transmitter 17 so as to store/compress the user data with the video data. A partial memory region is provided as a region stored with the user data by the set-up of the driver.

The LCD apparatus 20 comprises the external apparatus connecting part 22, a body connection part 29, a TMDS receiver 27 to extract the video signal received through the body connection part 29, a buffer 26, a scaler 23 to adjust the RGB video signal according to the size of an LCD panel 21, the LCD panel 21 to display a picture according to a picture signal received from the scaler 23, and a control part to control the separation of the data provided from the TMDS receiver 27, thus outputting the user data to the external apparatus 1 connected to the external apparatus connecting part 22 through the buffer 26 and transmitting the video data to the scaler 23.

The control part includes a signal separating part 25 to separate extracted digital data into the video signal and the user data, and a micom 28 to control respective driving parts including the scaler 23. The micom 28 determines resolution on the basis of the H/V synchronizing signal outputted from the signal separating part 25 and then changes the setup of the scaler 23.

The signal separating part 25 extracts the user data from the digital data outputted from RGB video data pins of the TMDS receiver 27. Upon extracting the data, the signal separating part 25 recognizes 77.5% of digital data inputted per one clock as the video data to provide the video data to the scaler 23, and 2.5% thereof as the user data to provide the user data to the buffer 26. The user data is thus stored temporarily in the buffer 26 and outputted to the external apparatus 1 through the external apparatus connecting part 22.

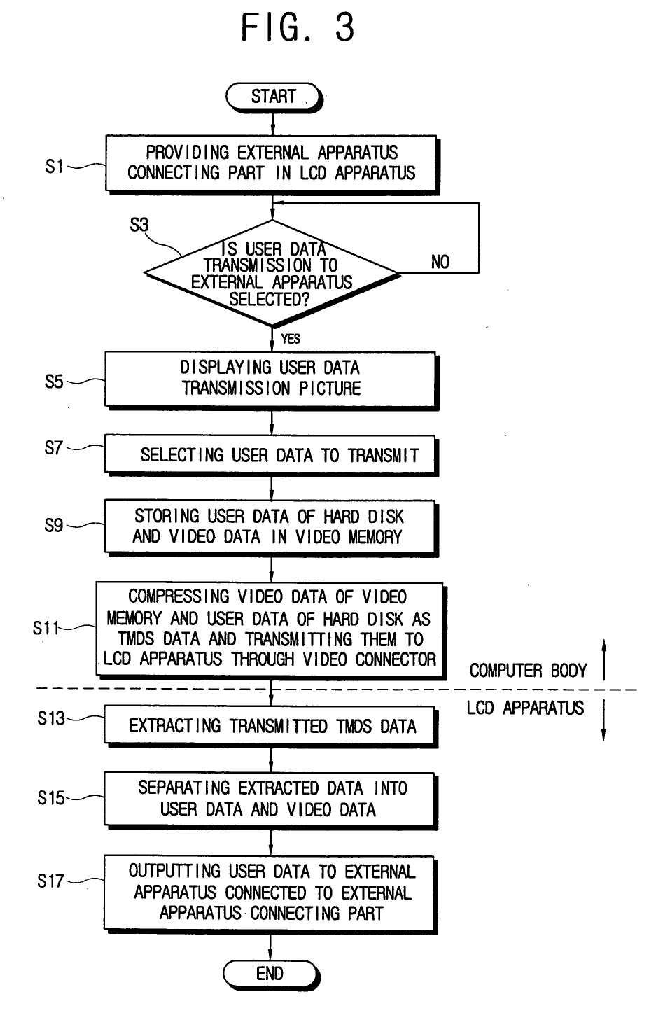

FIG. 3 is a flow diagram illustrating a data transmitting method of a computer system having the control block of FIG. 2. As shown in FIG. 3, the external apparatus connecting part 22 is provided in the LCD apparatus 20 (S1). If data transmission to the external apparatus 1 is selected (S3), a user data transmission program based on the OS (Operating System) is operated. The user data transmitting program changes the set-up of the video memory 15 and the TMDS transmitter 17 so as to store/compress the user data.

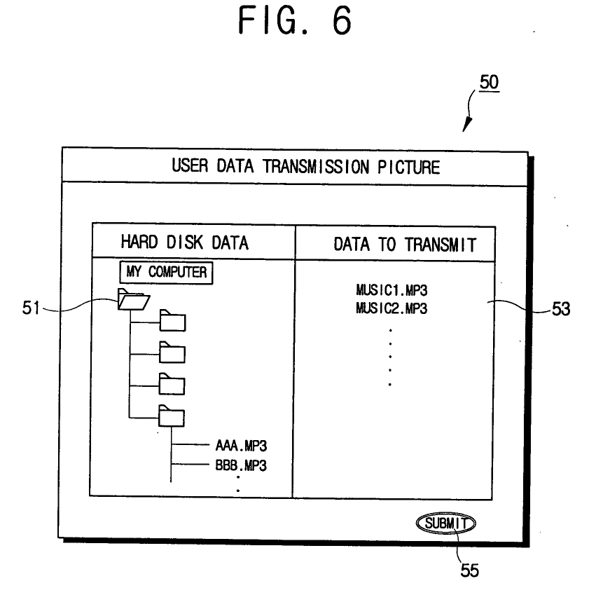

If the user data transmitting program is operated, a user data transmission picture 50 shown in FIG. 6 is displayed on a screen of the LCD apparatus 20 (S5). If the user data to transmit is selected on the user data transmission picture 50 (S7), the user data stored in the hard disk 13 is stored in the video memory 15 by an order of the CPU (not shown) (S9). The video data of the video memory 15 and the user data of the hard disk 13 are compressed as TMDS data according to the TMDS standard and are transmitted to the LCD apparatus 20 through the video connector 19 (S11). The LCD apparatus 20 extracts the transmitted TMDS data (S13). The extracted data is separated into the user data and the video data in the signal separating part 25 (S15). The user data is outputted to the external apparatus 1 connected to the external apparatus connecting part 22 through the buffer 26 (S17) and the video data is provided/processed in the scaler 23.

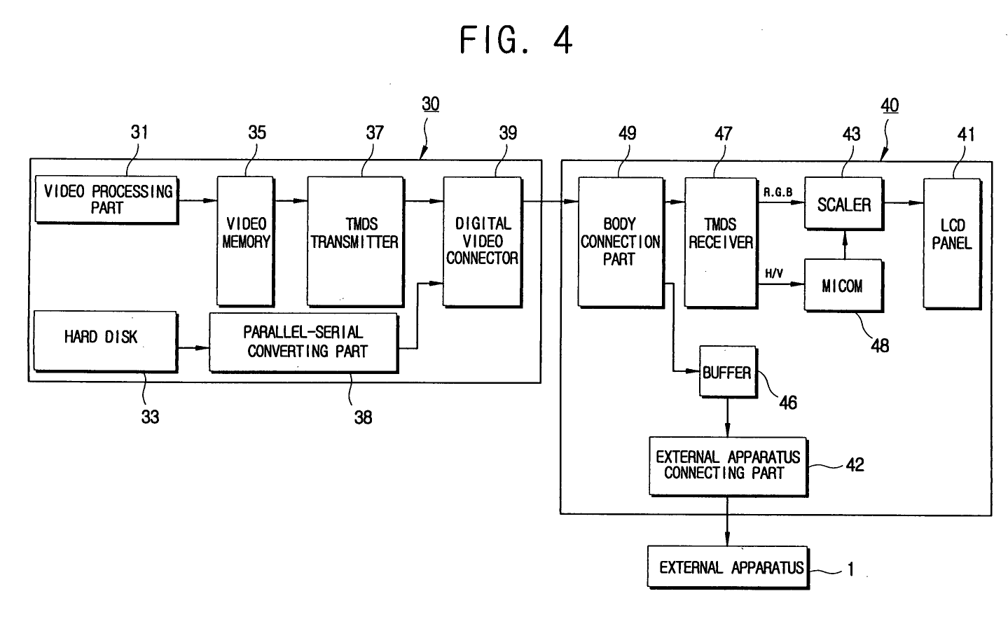

FIG. 4 is a control block diagram of the computer system according to another embodiment of the present invention. Hereinafter, repetitive description of like elements will be avoided as necessary. As shown in FIG. 4, a computer body 30 comprises a digital video connector 39 provided with a user data transmission pin for transmitting data of a hard disk 33, a parallel-serial converting part 38 to convert parallel data outputted from a main memory (not shown) temporarily stored with the user data of the hard disk 33 to serial data. The digital video connector 39 is a DVI (Digital Visual Interface) connector, and extra pins of the DVI connector (9^{th} and 10^{th} pins of a pin set-up table of a digital video connector of FIG. 7) are used as user data transmission pins.

The parallel-serial converting part 38 is provided with data from the hard disk 33 and then transmits the user data converted into serial data through the data transmission pin to an LCD apparatus 40 via the digital video connector 39. Accordingly, the LCD apparatus 40 outputs a digital signal provided from the data transmission pins of the digital video connector 39 to an external apparatus 1 (MP3 player) connected to an external apparatus connecting part 42 via a buffer 46.

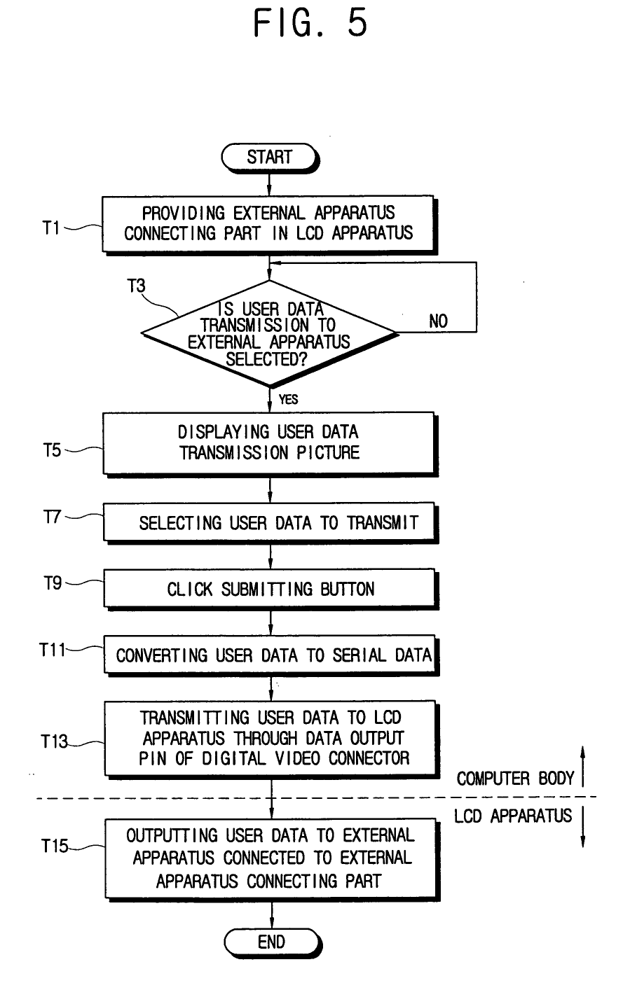

FIG. 5 is a flow diagram illustrating a data transmitting method of a computer system having the control block of FIG. 4. As shown in FIG. 5, the external apparatus connecting part 42 is provided in the LCD apparatus 40 (T1). If data transmission to the external apparatus 1 is selected (T3), a user data transmitting program is operated. If the user data transmitting program is operated, the user data transmission picture 50 shown in FIG. 6 is displayed on a screen of the LCD apparatus 40 (T5). After the user data to transmit is selected on the user data transmission picture 50 (T7), if a submitting button 55 (refer to FIG. 6) of the user data transmission picture 50 is clicked (T9), the user data of the hard disk 33 is provided to the parallel-serial converting part 38 and converted into serial data by an order of the CPU (not shown) (T11). The user data converted into the serial data is outputted to the LCD apparatus 40 through a data output pin of the digital video connector 39 (T13). In the LCD apparatus 40, the user data inputted through a body connector 49 is temporarily stored in the buffer 26 and is outputted to the external apparatus 1 connected to the external apparatus connecting part 42 (T15).

FIG. 6 is a view illustrating a user interface picture 50 of a program transmitting the user data stored in a hard disk 13 or 33 of the computer system to a display apparatus 20 or 40. As shown in FIG. 6, the user data transmission picture 50 is provided with a user data block 51 in which the data stored in the hard disk 13 or 33 is displayed as a file or a folder type, a data block 53 to display a selected data and the submitting button 55 for transmitting files selected in the user data block 51 to the LCD apparatus 20 or 40. If a user clicks the submitting button 55 after selecting predetermined data, the selected data is outputted to the external apparatus 1 connected to the LCD apparatus 20 or 40 via the LCD apparatus 20 or 40 to be stored therein.

In the above embodiment, the external apparatus 1 according to the present invention is described as an MP3 player, but it can be applied to other computer bodies or other data apparatuses.

With the above configuration, a buffer function is implemented in the LCD apparatus, so that the LCD apparatus receives the video signal outputted from the video processing part of the computer body and the user data stored in the hard disk via the digital video connector, and outputs them to the external apparatus.

As described above, according to the present invention, a computer system enabling data stored in a hard disk to be outputted to an external apparatus through a display apparatus and a data transmitting method thereof are provided.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partial/within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc., etc.

Although a few embodiments of the present invention have been shown and described, it will be appreciated by those skilled in the art that changes may be made in these embodiments without departing from the principles and spirit of the present invention, the scope of which is defined in the appended claims and their equivalents.

1. A computer system comprising:
a computer body, comprising:
a hard disk to store user data, a video connector to transmit data,
a video processing part to generate video data, a video memory to temporarily store the video data generated through the video processing part and the user data stored in the hard disk,
a data transmitting part to output the video data and the user data temporarily stored in the video memory through the video connector; and
a display apparatus, comprising:
a display part,
a body connection part to connect to the video connector of the computer body,
an external apparatus connecting part to connect to an external apparatus,
a data receiving part to receive the video data and the user data provided from the computer body through the body connection part,
a control part to display the video data received through the data receiving part to the display part and to output the user data to the external apparatus connected to the external apparatus connecting part.

2. The computer system according to claim 1, wherein the data transmitting part and the data receiving part respectively comprises a TMDS (Transition Minimized Differential Signals) transmitter and a TMDS receiver to compress/extract data according to a TMDS-based digital data transmission standard.

3. The computer system according to claim 2, wherein the TMDS transmitter comprises RGB data output pins, and compresses the user data and the video data provided from the video memory in a predetermined ratio to output a compressed user and video data through the respective RGB data output pins.

4. The computer system according to claim 2, wherein the control part comprises a signal separating part to separate digital data extracted in the data receiver into the video data and the user data.

5. The computer system according to claim 1, wherein the display apparatus has a buffer temporarily storing the user data received through the data receiving part.

6. The computer system of claim 5, wherein the external apparatus connecting part outputs a digital signal from the data transmitting part to the external apparatus via the buffer.

7. The computer system of claim 1, wherein the computer body further comprises a parallel-serial converting part to convert the user data to serial data, wherein the user data is parallel data.

8. The computer system according to claim 2, wherein the computer body further comprises a parallel-serial converting part to convert the user data stored in the hard disk to serial data, wherein the parallel-serial converting part outputs a converted serial data to the display apparatus through a predetermined pin of the video connector.

9. A data transmitting method of a computer system including a computer body having a hard disk to store user data, a video processing part to generate video data, and a video connector through which the generated video data is outputted; and a display apparatus having a body connection part to be connected to the video connector, comprising:
providing an external apparatus connecting part in the display apparatus;
transmitting data to the display apparatus through the video connector; and
displaying the video data of a transmitted data as a picture and outputting the user data of the transmitted data to an external apparatus connected to the external apparatus connecting part.

10. The data transmitting method of the computer system according to claim 9, further comprising:
compressing the user data and the video data according to a TMDS-based digital data transmission standard, before transmitting the data from the computer body to the display apparatus.

11. The data transmitting method of the computer system according to claim 10, further comprising:
extracting the data; and
separating an extracted data into the video data and the user data.

12. The data transmitting method of the computer system according to claim 9, further comprising:
setting up a predetermined pin of the video connector as a data transmission pin; and converting the user data to serial data,
wherein the transmitting of the data comprises outputting the serial data to the display apparatus through the data transmission pin.

13. The data transmitting method of claim 9, further comprising:
storing the video data and the user data of the hard disk in a predetermined memory,
wherein the data that is transmitted is the video data and the user data.

14. The data transmitting method of claim 9, further comprising:
converting the user data to serial data,
wherein the data that is transmitted is the video data and the serial data.

15. A computer system, comprising: a processing unit, comprising;
a video processor to generate video data, a storage unit to store user data, and
a data transmitter to transmit the video data and the user data; an external storage unit to store the user data; and
a display unit, which is connected to the processing unit via a video connector, and which is connected to the external storage unit via an external storage unit connector, to display the video data and to transmit the user data to the external storage unit.
